(19) United States
(12) Patent Application Publication
(10) Pub. No.: US 2025/0274017 A1
(43) Pub. Date: Aug. 28, 2025

(54) ELECTRIC COMPRESSOR

(71) Applicant: KABUSHIKI KAISHA TOYOTA JIDOSHOKKI, Kariya-shi (JP)

(72) Inventors: Yoshifumi TADA, Kariya-shi (JP); Katsuya USAMI, Kariya-shi (JP); Atsushi OSHIMA, Kariya-shi (JP); Kenta MATSUOKA, Kariya-shi (JP)

(73) Assignee: KABUSHIKI KAISHA TOYOTA JIDOSHOKKI, Kariya-shi (JP)

(21) Appl. No.: 19/023,688

(22) Filed: Jan. 16, 2025

(30) Foreign Application Priority Data
Feb. 28, 2024 (JP) 2024-028330

(51) Int. Cl. H02K 9/22; H02K 5/06; H02K 11/33

(52) U.S. Cl. CPC H02K 9/223; H02K 5/06; H02K 11/33

(57) ABSTRACT

An electric compressor includes a compression part, an electric motor, an inverter, and a housing having a motor housing defining a suction chamber, an inverter housing defining an inverter accommodating chamber, and a separation wall. The inverter accommodating chamber has a first accommodating space and a second accommodating space. The inverter has a heat generation component in the second accommodating space. The second accommodating space has an outer peripheral accommodating space that is disposed next to the suction chamber with the motor housing interposed therebetween. The heat generation component is accommodated in the outer peripheral accommodating space. A heat transferring member is provided between the motor housing and the heat generation component. The heat transferring member is in contact with the motor housing and the heat generation component.

### CROSS-REFERENCE OF THE RELATED APPLICATION

This application claims priority to Japanese Patent Application No. 2024-028330 filed on Feb. 28, 2024, the entire disclosure of which is incorporated herein by reference.

### BACKGROUND ART

The present disclosure relates to an electric compressor.

An electric compressor described in Japanese Patent Publication Application No. 2017-172509 includes a compression part that compresses a fluid, an electric motor that drives the compression part, an inverter that drives the electric motor, and a housing made of metal in which the compression part, the electric motor, and the inverter are accommodated.

The housing has a motor housing formed in a cylindrical shape, an inverter housing, and a separation wall. The motor housing accommodates the electric motor and defines a suction chamber into which the fluid is sucked. The inverter housing defines an inverter accommodating chamber in which the inverter is accommodated. The separation wall separates the suction chamber from the inverter accommodating chamber in an axial direction of the motor housing. The inverter accommodating chamber has a first accommodating space and a second accommodating space. The first accommodating space is disposed next to the suction chamber in the axial direction of the motor housing with the separation wall interposed therebetween. The second accommodating space is located outside the outer peripheral surface of the motor housing when viewed in the axial direction of the motor housing. The inverter has a first heat generation component that is accommodated in the first accommodating space and a second heat generation component that is accommodated in the second accommodating space.

The first heat generation component is easily cooled by the fluid sucked into the suction chamber, because the first heat generation component and the suction chamber are arranged in the axial direction of the motor housing with the separation wall interposed therebetween. In contrast, the second heat generation component is hardly cooled, because the second heat generation component and the suction chamber are not arranged in the axial direction of the motor housing.

### SUMMARY

In accordance with an aspect of the present disclosure, there is provided an electric compressor that includes a compression part configured to compress a fluid, an electric motor configured to drive the compression part, an inverter configured to drive the electric motor, and a housing made of metal. The housing has a motor housing formed in a cylindrical shape, the motor housing accommodating the electric motor and defining a suction chamber into which the fluid is sucked, an inverter housing defining an inverter accommodating chamber accommodating the inverter, and a separation wall separating the suction chamber from the inverter accommodating chamber in an axial direction of the motor housing.

The inverter accommodating chamber has a first accommodating space that is disposed next to the suction chamber in the axial direction of the motor housing with the separation wall interposed between the first accommodating space and the suction chamber and a second accommodating space that is located outside an outer peripheral surface of the motor housing when viewed in the axial direction of the motor housing. The inverter has a heat generation component that is accommodated in the second accommodating space. The second accommodating space has an outer peripheral accommodating space that is disposed next to the suction chamber in a direction perpendicular to the axial direction of the motor housing with the motor housing interposed between the second accommodating space and the suction chamber. The heat generation component is accommodated in the outer peripheral accommodating space. A heat transferring member is provided between the motor housing and the heat generation component. The heat transferring member is in contact with both of the motor housing and the heat generation component.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a cross-sectional view illustrating a part of an electric compressor according to a first embodiment;

FIG. 2 is a cross-sectional view illustrating a part of the electric compressor according to the first embodiment;

FIG. 3 is a perspective view of a housing main body and an inverter;

FIG. 4 is a perspective view of a coil unit;

FIG. 5 is a cross-sectional view taken along a line V-V of FIG. 2;

FIG. 6 is a cross-sectional view illustrating an electric compressor according to a second embodiment;

FIG. 7 is a cross-sectional view illustrating an electric compressor according to a third embodiment;

FIG. 8 is a cross-sectional view illustrating an electric compressor according to a fourth embodiment;

FIG. 9 is a side view illustrating the electric compressor according to the fourth embodiment; and

FIG. 10 is a cross-sectional view illustrating an accommodating method of a second heat generation component according to the fourth embodiment.

### DETAILED DESCRIPTION OF THE EMBODIMENTS

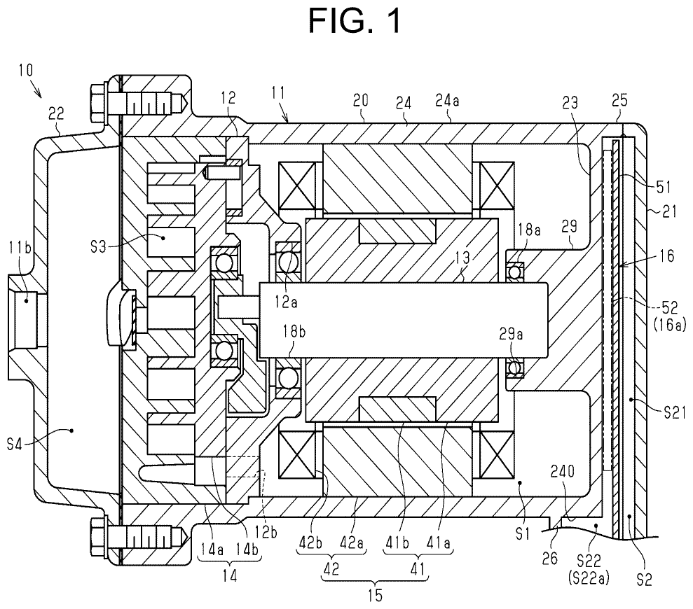

The following will describe an embodiment of an electric compressor with reference to FIG. 1 to FIG. 5. The electric compressor of the present embodiment is used in an air conditioner for vehicles.

As illustrated in FIG. 1, an electric compressor 10 includes a housing 11, a shaft supporting member 12, a rotary shaft 13, a compression part 14, and an electric motor 15, and an inverter 16. The shaft supporting member 12, the rotary shaft 13, the compression part 14, the electric motor 15, and the inverter 16 are accommodated in the housing 11. The compression part 14 compresses a refrigerant as a fluid. The electric motor 15 rotates the rotary shaft 13 to drive the compression part 14. The inverter 16 drives the electric motor 15.

### Housing

The housing 11 of the present embodiment includes a housing main body 20, a first cover 21, and a second cover 22. The housing main body 20, the first cover 21, and the second cover 22 are each made of metal. Thus, the housing 11 is made of metal. In the present embodiment, the housing main body 20, the shaft supporting member 12, the first cover 21, and the second cover 22 are each made of aluminum.

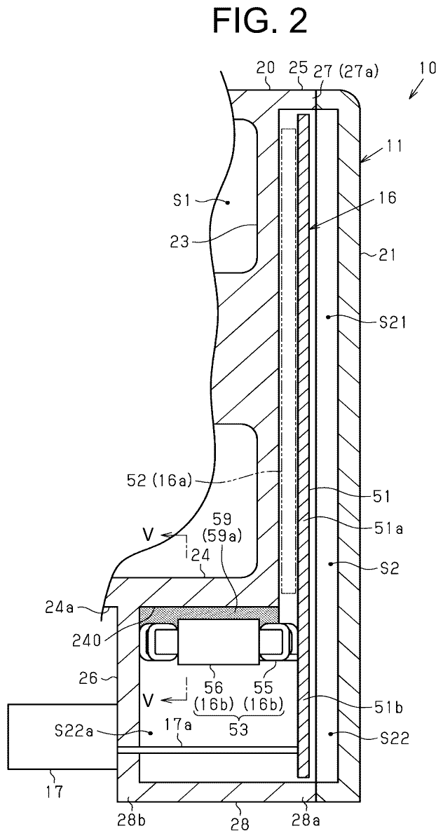

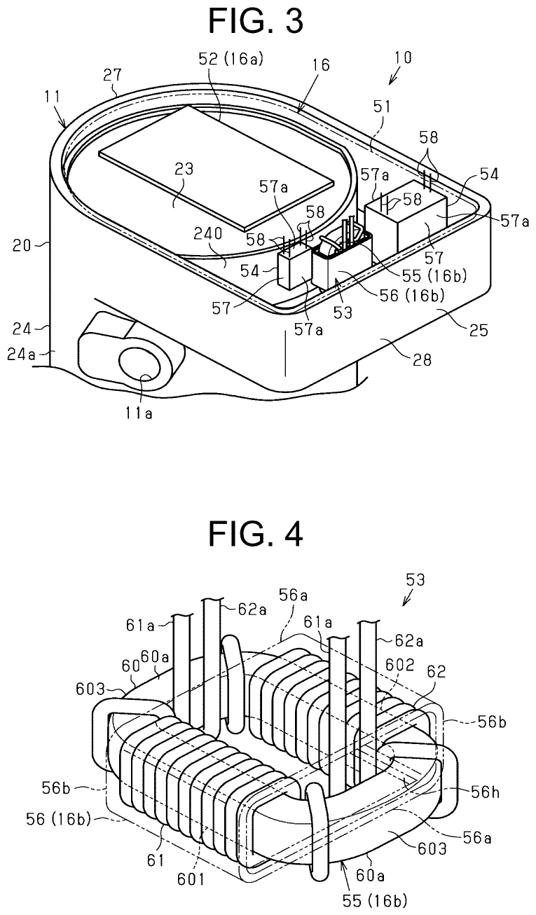

As illustrated in FIG. 2 and FIG. 3, the housing main body 20 includes a separation wall 23 formed in a plate shape, a motor housing 24 formed in a cylindrical shape, an inverter housing 25 formed in a tubular shape, and a closing wall 26 formed in a plate shape.

The motor housing 24 extends from an outer peripheral portion of the separation wall 23 toward one side in a thickness direction of the separation wall 23. An axial direction of the motor housing 24 coincides with the thickness direction of the separation wall 23. A suction port 11a is formed in the motor housing 24. The suction port 11a is connected to a first end of an external refrigerant circuit, which is not illustrated.

The inverter housing 25 extends from a part of the outer peripheral portion of the separation wall 23 toward the other side in the thickness direction of the separation wall 23. That is, a direction in which the inverter housing 25 extends from the separation wall 23 is an opposite direction of a direction in which the motor housing 24 extends from the separation wall 23. A shape of the inverter housing 25 is larger than a shape of the motor housing 24. The inverter housing 25 has a base portion 27 continuous with the outer peripheral portion of the separation wall 23 and an extending portion 28 that is located outside an outer peripheral surface 24a of the motor housing 24 in a direction perpendicular to the axial direction of the motor housing 24.

A length of the extending portion 28 in the axial direction of the motor housing 24 is greater than that of the base portion 27 in the axial direction of the motor housing 24. The extending portion 28 has a first end portion 28a and a second end portion 28b. The first end portion 28a and the second end portion 28b are end portions of the extending portion 28 in the axial direction of the motor housing 24. The first end portion 28a of the extending portion 28 is located at the same position as a distal end portion 27a of the base portion 27 in the axial direction of the motor housing 24. The second end portion 28b of the extending portion 28 is located closer to the motor housing 24 than the separation wall 23 in the axial direction of the motor housing 24. A portion of the extending portion 28, which is located closer to the motor housing 24 than the separation wall 23 in the axial direction of the motor housing 24, is located radially outside the motor housing 24.

The closing wall 26 connects the outer peripheral surface 24a of the motor housing 24 to the second end portion 28b of the extending portion 28 of the inverter housing 25. The closing wall 26 is located closer to the motor housing 24 than the separation wall 23 in the axial direction of the motor housing 24.

A connector 17 is provided on the closing wall 26. The connector 17 extends from the closing wall 26 away from the inverter housing 25 in the axial direction of the motor housing 24. The connector 17 is electrically connected to a power supply mounted on a vehicle. Here, the power supply and the vehicle are not illustrated. The connector 17 is electrically connected to a circuit board 51, which will be described later, through a wire 17a.

As illustrated in FIG. 1, the shaft supporting member 12 is disposed in the motor housing 24. The shaft supporting member 12 has a shaft insertion hole 12aand a communication hole 12b. A suction chamber S1 is defined by an inner peripheral surface of the motor housing 24, the separation wall 23, and the shaft supporting member 12.

The separation wall 23 has a boss 29. The boss 29 protrudes from a surface that defines the suction chamber S1 in the separation wall 23. The boss 29 has a recess 29a. The recess 29a is recessed from an end surface of the boss 29 at a center portion thereof.

A shape of the first cover 21 corresponds to the shape of the inverter housing 25.

As illustrated in FIG. 2, the first cover 21 is connected to the inverter housing 25. Specifically, the first cover 21 is connected to the distal end portion 27a of the base portion 27 and the first end portion 28a of the extending portion 28. The first cover 21 covers an opening of the inverter housing 25.

An inverter accommodating chamber S2 is defined by the separation wall 23, the closing wall 26, a portion of the outer peripheral surface 24a of the motor housing 24, an inner peripheral surface of the inverter housing 25, and an inner surface of the first cover 21. The separation wall 23 separates the suction chamber S1 from the inverter accommodating chamber S2 in the axial direction of the motor housing 24.

The inverter accommodating chamber S2 has a first accommodating space S21 and a second accommodating space S22. The first accommodating space S21 is disposed next to the suction chamber S1 in the axial direction of the motor housing 24. The second accommodating space S22 is located outside the outer peripheral surface 24a of the motor housing 24 when viewed in the axial direction of the motor housing 24.

The second accommodating space S22 has an outer peripheral accommodating space S22a that is disposed next to the suction chamber S1 in the direction perpendicular to the axial direction of the motor housing 24 with a part of a peripheral wall of the motor housing 24 interposed therebetween. The outer peripheral accommodating space S22a is defined by the outer peripheral surface 24a of the motor housing 24, the portion of the extending portion 28, which is located closer to the motor housing 24 than the separation wall 23 in the axial direction of the motor housing 24, and the closing wall 26.

In the following description, a part of the outer peripheral surface 24a of the motor housing 24, which defines the outer peripheral accommodating space S22a is referred to as a separation surface 240. As illustrated in FIG. 3, the suction port 11a and the separation surface 240 of the motor housing 24 are arranged in the axial direction of the motor housing 24.

As illustrated in FIG. 1, the second cover 22 is connected to a distal end portion of the motor housing 24. The second cover 22 covers an opening of the motor housing 24. A discharge port 11b is formed in the second cover 22. The discharge port 11b is connected to a second end, which is the opposite end of the first end of the external refrigerant circuit.

The electric compressor 10 of the present embodiment is mounted on a vehicle with the suction chamber S1 and the first accommodating space S21 of the inverter accommodating chamber S2 arranged horizontally. However, a posture of the electric compressor 10 mounted on the vehicle may be changed as appropriate. In addition, the first accommodating space S21 of the inverter accommodating chamber S2 may be located vertically above or below the second accommodating space S22, and may be disposed horizontally next to the second accommodating space S22.

The rotary shaft 13 is accommodated in the motor housing 24. The rotary shaft 13 extends in the axial direction of the motor housing 24. A first shaft end portion of the rotary shaft 13 is inserted in the recess 29a of the boss 29. The first shaft end portion of the rotary shaft 13 is rotatably supported by the boss 29 through a first bearing 18a. A second shaft end portion located opposite to the first shaft end portion of the rotary shaft 13 is inserted in the shaft insertion hole 12a of the shaft supporting member 12. The second shaft end portion of the rotary shaft 13 is rotatably supported by the shaft supporting member 12 through a second bearing 18b.

The compression part 14 is accommodated in the motor housing 24. The compression part 14 is disposed between the shaft supporting member 12 and the second cover 22 in the axial direction of the motor housing 24. The compression part 14 of the present embodiment is of a scroll type. The compression part 14 has a fixed scroll 14a and a movable scroll 14b. The fixed scroll 14a is held between the shaft supporting member 12 and the second cover 22 to be fixed to the housing 11. The movable scroll 14b is disposed so as to face the fixed scroll 14a. A compression chamber S3 whose volume is changeable is defined between the fixed scroll 14a and the movable scroll 14b. The compression chamber S3 communicates with the suction chamber S1 through the communication hole 12b. A discharge chamber S4 is defined by the fixed scroll 14a and an inner surface of the second cover 22. The compression chamber S3 communicates with the discharge chamber S4.

The electric motor 15 is accommodated in the suction chamber S1. That is, the suction chamber S1 also serves as a motor accommodating chamber in which the electric motor 15 is accommodated. The electric motor 15 has a rotor 41 and a stator 42. The rotor 41 has a rotor core 41a formed in a cylindrical shape and a plurality of permanent magnets 41b. The rotor core 41a is fixed to the rotary shaft 13. The plurality of permanent magnets 41b are buried in the rotor core 41a. The plurality of permanent magnets 41b are disposed at regular intervals in a circumferential direction of the rotor core 41a. The stator 42 surrounds the rotor 41. The stator 42 has a stator core 42a formed in a cylindrical shape and a motor coil 42b. The stator core 42a is fixed to the inner peripheral surface of the motor housing 24. The motor coil 42b is wound around the stator core 42a.

When the motor coil 42b is electrified, the rotor 41 rotates. The rotary shaft 13 rotates integrally with the rotor 41. The compression part 14 is driven by the rotation of the rotary shaft 13. When the compression part 14 is driven, the refrigerant is sucked into the suction chamber S1 from the external refrigerant circuit through the suction port 11a. The refrigerant sucked into the suction chamber S1 flows into the compression chamber S3 through the communication hole 12b, and then, is compressed by the compression part 14. The refrigerant compressed by the compression part 14 is discharged to the discharge chamber S4. The refrigerant discharged to the discharge chamber S4 is discharged to the external refrigerant circuit through the discharge port 11b.

### Inverter

As illustrated in FIG. 2, the inverter 16 is accommodated in the inverter accommodating chamber S2. The inverter 16 includes the circuit board 51, an inverter circuit 52, a coil unit 53, and two capacitors 54 (see FIG. 3). The coil unit 53 has a choke coil 55 and a conductive ring 56. The choke coil 55 and the capacitors 54 form a LC resonance circuit. The inverter circuit 52, the choke coil 55, the conductive ring 56, and the capacitors 54 are heat generation components that generate heat during an operation of the inverter 16.

A thickness direction of the circuit board 51 coincides with the axial direction of the motor housing 24. A shape of the circuit board 51 is larger than the shape of the motor housing 24. The circuit board 51 has a first board portion 51a that is accommodated in the first accommodating space S21 of the inverter accommodating chamber S2 and a second board portion 51b that is accommodated in the second accommodating space S22 of the inverter accommodating chamber S2.

The inverter circuit 52 performs a switching operation to drive the electric motor 15. The inverter circuit 52 is mounted on the circuit board 51. In the present embodiment, the inverter circuit 52 is mounted on the first board portion 51a of the circuit board 51. Thus, the inverter circuit 52 is a first heat generation component 16a that is accommodated in the first accommodating space S21 of the inverter accommodating chamber S2.

### Coil Unit

As illustrated in FIG. 4, the choke coil 55 of the coil unit 53 had a core 60, a first coil 61, and a second coil 62.

The core 60 is formed in a ring shape. The core 60 is made of a ferromagnet. The core 60 is, for example, a ferrite core. The core 60 has a first winding portion 601, a second winding portion 602, and a pair of connecting portions 603. The first winding portion 601 and the second winding portion 602 extend straight. The first winding portion 601 and the second winding portion 602 extend in parallel to each other. One of the connecting portions 603 connects one end portion of the first winding portion 601 and one end portion of the second winding portion 602, and the other of the connecting portions 603 connects the other end portion of the first winding portion 601 and the other end portion of the second winding portion 602. The core 60 has a pair of core end surfaces 60a. The core end surfaces 60a are end surfaces of the core 60 in an axial direction thereof.

The first coil 61 is wound around the first winding portion 601 of the core 60. Both end portions of the first coil 61 are drawn from the core 60 as a pair of first drawing portions 61a. The second coil 62 is wound around the second winding portion 602 of the core 60. Both end portions of the second coil 62 are drawn from the core 60 as a pair of second drawing portions 62a

The conductive ring 56 is formed in a ring shape as illustrated by a long dashed double short dashed line in FIG. 4. The conductive ring 56 is made of a conductive material. The conductive ring 56 is, for example, made of cupper or aluminum. The conductive ring 56 has a pair of first plate portions 56a and a pair of second plate portions 56b.

The pair of first plate portion 56a and the pair of second plate portions 56b are each formed in a rectangular plate shape. The first plate portions 56a face each other. A through hole 56h is formed in one of the pair of first plate portions 56a. One of the second plate portions 56b connects one end portion of the one of the pair of the first plate portions 56a to one end portion of the other of the pair of the first plate portions 56a. The other of the second plate portions 56b connects the other end portion of the one of the pair of the first plate portions 56a to the other end portion of the other of the pair of the first plate portions 56a. The second plate portions 56b face each other. A direction in which the first plate portions 56a face each other is perpendicular to a direction in which the second plate portions 56b face each other.

A part of the choke coil 55 is disposed inside the conductive ring 56. The axial direction of the core 60 is perpendicular to an axial direction of the conductive ring 56. The first winding portion 601 and the second winding portion 602 of the core 60, a portion of the first coil 61 wound around the first winding portion 601, and a portion of the second coil 62 wound around the second winding portion 602 are located inside the conductive ring 56. The pair of the first plate portions 56a of the conductive ring 56 is disposed so as to hold the choke coil 55 therebetween in the axial direction of the core 60. The pair of the second plate portions 56b of the conductive ring 56 is disposed so as to hold the choke coil 55 therebetween in a direction in which the first coil 61 and the second coil 62 are arranged.

When a normal mode current flows through the first coil 61 and the second coil 62, magnetic flux leaks from the core 60. An induced current flows through the conductive ring 56 so that magnetic flux that opposes change of leakage magnetic flux leaked from the core 60 is generated. Then, the induced current flowing through the conductive ring 56 is converted to thermal energy, so that normal mode noise is reduced.

As illustrated in FIG. 2, the coil unit 53 is mounted on the circuit board 51. The pair of the first drawing portions 61a and the pair of the second drawing portions 62a of the choke coil 55 are electrically connected to the circuit board 51. In the present embodiment, the coil unit 53 is mounted on the second board portion 51b of the circuit board 51. Accordingly, the coil unit 53 is a second heat generation component 16b as the heat generation component, which is accommodated in the second accommodating space S22 of the inverter accommodating chamber S2. Specifically, each of the choke coil 55 and the conductive ring 56 that constitutes the coil unit 53 is the second heat generation component 16b.

A part of the coil unit 53 is accommodated in the outer peripheral accommodating space S22a of the second accommodating space S22. Accordingly, a part of the coil unit 53 and the suction chamber S1 are arranged in the direction perpendicular to the axial direction of the motor housing 24 with a part of the peripheral wall of the motor housing 24 interposed therebetween. In the present embodiment, the axial direction of the core 60 is perpendicular to the axial direction of the motor housing 24. One of the pair of core end surfaces 60a faces the separation surface 240 of the motor housing 24 with a potting material 59 interposed therebetween. The potting material 59 will be described later. Of the pair of the first plate portions 56a of the conductive ring 56, the first plate portion 56a having the through hole 56h is located between the motor housing 24 and the choke coil 55.

### Capacitor

As illustrated in FIG. 3, each of the capacitors 54 has a capacitor main body 57 and a plurality of leads 58. The capacitor main body 57 of the present embodiment is formed in a rectangular parallelepiped shape. The capacitor main body 57 has a pair of capacitor main surfaces 57a. The capacitor main surfaces 57a are each an outer surface with the largest area among six outer surfaces of the capacitor main body 57. A direction in which the capacitor main surfaces 57a are arranged is defined as a thickness direction of the capacitor main body 57.

The capacitors 54 are mounted on the circuit board 51. The leads 58 of each of the capacitors 54 are electrically connected to the circuit board 51. In the present embodiment, each of the capacitors 54 is mounted on the second board portion 51b of the circuit board 51. Accordingly, each of the capacitors 54 is the second heat generation component 16b as the heat generation component, which is accommodated in the second accommodating space S22 of the inverter accommodating chamber S2. The two capacitors 54 are disposed so as to hold the choke coil 55 therebetween. In other words, the choke coil 55 is located between the two capacitors 54.

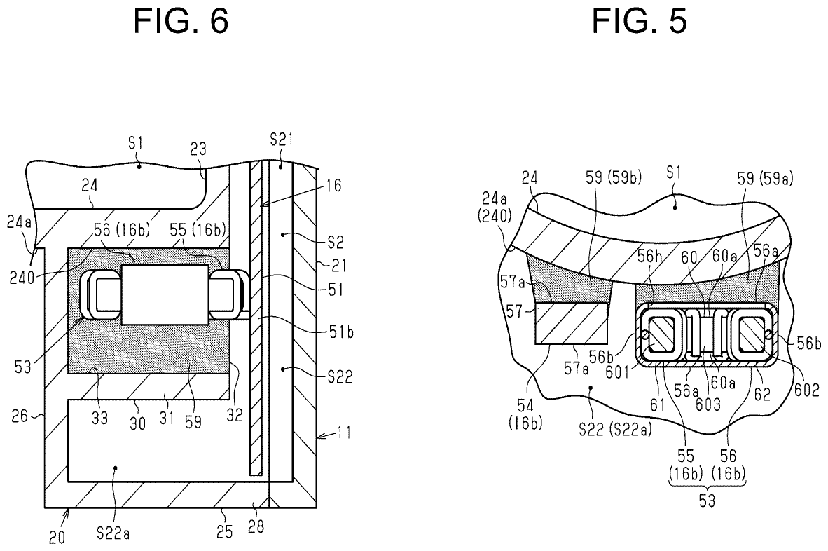

As illustrated in FIG. 3 and FIG. 5, a part of each of the capacitors 54 is accommodated in the outer peripheral accommodating space S22a of the second accommodating space S22. Accordingly, a part of each of the capacitors 54 and the suction chamber S1 are arranged in the direction perpendicular to the axial direction of the motor housing 24 with a part of the peripheral wall of the motor housing 24 interposed therebetween. In the present embodiment, the thickness direction of the capacitor main body 57 is perpendicular to the axial direction of the motor housing 24. One of the pair of the capacitor main surfaces 57a faces the separation surface 240 of the motor housing 24 with the potting material 59, which will be described later, interposed therebetween.

### Potting Material (Heat Transferring Member)

As illustrated in FIG. 2 and FIG. 5, in the outer peripheral accommodating space S22a, the potting material 59 as a heat transferring member is provided between the outer peripheral surface 24a of the motor housing 24 and each of the second heat generation components 16b. The potting material 59 is in contact with both of the motor housing 24 and each of the second heat generation components 16b. Note that illustrations of the potting material 59 are omitted in FIG. 1 and FIG. 3.

As illustrated in FIG. 5, the potting material 59 of the present embodiment includes a coil-heat transfer portion 59a and capacitor-heat transfer portions 59b. The coil-heat transfer portion 59a is disposed between the motor housing 24 and the choke coil 55 of the coil unit 53. The coil-heat transfer portion 59a is in contact with both of the outer peripheral surface 24a of the motor housing 24 and the choke coil 55. In addition, the coil-heat transfer portion 59a is also disposed between the motor housing 24 and the conductive ring 56 of the coil unit 53. The coil-heat transfer portion 59a is in contact with both of the outer peripheral surface 24a of the motor housing 24 and the one of the first plate portions 56a of the conductive ring 56. Each of the capacitor-heat transfer portions 59b is disposed between the motor housing 24 and the corresponding capacitor 54. Each of the capacitor-heat transfer portions 59b is in contact with both of the outer peripheral surface 24a of the motor housing 24 and the one of the capacitor main surfaces 57a of the corresponding capacitor 54.

### Operation of Present Embodiment

The following will describe an operation of the present embodiment.

The inverter accommodating chamber S2 has the first accommodating space S21 and the second accommodating space S22. The first accommodating space S21 is disposed next to the suction chamber S1 in the axial direction of the motor housing 24. The second accommodating space S22 is located outside the outer peripheral surface 24a of the motor housing 24 when viewed in the axial direction of the motor housing 24. The inverter 16 has the choke coil 55, the conductive ring 56, and the capacitors 54 as the second heat generation components 16b, which are accommodated in the second accommodating space S22.

The second accommodating space S22 of the present embodiment has the outer peripheral accommodating space S22a that is disposed next to the suction chamber S1 in the direction perpendicular to the axial direction of the motor housing 24 with a part of the peripheral wall of the motor housing 24 interposed therebetween. The choke coil 55, the conductive ring 56, and the capacitors 54 are accommodated in the outer peripheral accommodating space S22a. The potting material 59 is disposed between the motor housing 24 and the choke coil 55, between the motor housing 24 and the conductive ring 56, and between the motor housing 24 and each of the capacitors 54. The potting material 59 is in contact with all of the motor housing 24, the choke coil 55, the conductive ring 56, and the capacitors 54.

With this configuration, the suction chamber S1 and each of the choke coil 55, the conductive ring 56, and the capacitors 54 are arranged in the direction perpendicular to the axial direction of the motor housing 24 with the potting material 59 and a part of the peripheral wall of the motor housing 24 interposed therebetween. With this arrangement, heat from each of the choke coil 55, the conductive ring 56, and the capacitors 54 is transferred to the motor housing 24 through the potting material 59. The motor housing 24 defines the suction chamber S1. Accordingly, the motor housing 24 is cooled by the refrigerant sucked into the suction chamber S1. That is, each of the choke coil 55, the conductive ring 56, and the capacitors 54 is cooled by the refrigerant in the suction chamber S1 through the potting material 59 and a part of the peripheral wall of the motor housing 24.

### Advantageous Effects of the Present Embodiment

The following will describe advantageous effects of the present embodiment.

(1-1) The second accommodating space S22 has the outer peripheral accommodating space S22a that is disposed next to the suction chamber S1 in the direction perpendicular to the axial direction of the motor housing 24 with a part of the peripheral wall of the motor housing 24 interposed therebetween. The second heat generation components 16b are accommodated in the outer peripheral accommodating space S22a. The potting material 59 is provided between the motor housing 24 and each of the second heat generation components 16b. The potting material 59 is in contact with both of the motor housing 24 and each of the second heat generation components 16b.

According to the above-described configuration, each of the second heat generation components 16b and the suction chamber S1 are arranged in the direction perpendicular to the axial direction of the motor housing 24 with the potting material 59 and a part of the peripheral wall of the motor housing 24 interposed therebetween. With this arrangement, the second heat generation components 16b are easily cooled by the refrigerant sucked into the suction chamber S1. Thus, the second heat generation components 16b are efficiently cooled.

In addition, a portion that defines the second accommodating space S22 in the housing 11 tends to vibrate as compared to the other portion of the housing 11. According to the above-described configuration, a portion that defines the outer peripheral accommodating space S22a in the housing 11 serves as a rib, so that it is suppressed that the portion that defines the second accommodating space S22 in the housing 11 vibrates.

(1-2) The inverter 16 has the choke coil 55 as the second heat generation component 16b. The choke coil 55 has the core 60 having the ring shape and the first coil 61 and the second coil 62 wound around the core 60. The choke coil 55 is positioned so that the axial direction of the core 60 intersects with the axial direction of the motor housing 24.

According to the above-described configuration, as compared with a case where the choke coil 55 is positioned so that the axial direction of the core 60 coincides with the axial direction of the motor housing 24, an area of the choke coil 55 when viewed in the axial direction of the motor housing 24 becomes smaller. Thus, the portion that defines the second accommodating space S22 in the housing 11 may be decreased in size in the direction perpendicular to the axial direction of the motor housing 24. As a result, it is further suppressed that the portion that defines the second accommodating space S22 in the housing 11 vibrates.

According to the above-described configuration, as compared with the case where the choke coil 55 is positioned so that the axial direction of the core 60 coincides with the axial direction of the motor housing 24, a length of the choke coil 55 in the axial direction of the motor housing 24 becomes larger. Thus, the portion that defines the outer peripheral accommodating space S22a in the housing 11 increases in size in the axial direction of the motor housing 24. As described above, the portion that defines the outer peripheral accommodating space S22a in the housing 11 serves as the rib. Thus, as the portion that defines the outer peripheral accommodating space S22a in the housing 11 increases in size in the axial direction of the motor housing 24, a function of the rib is enhanced. As a result, it is further suppressed that the portion that defines the second accommodating space S22 in the housing 11 vibrates.

(1-3) The inverter 16 has the capacitors 54 as the second heat generation components 16b. Each of the capacitors 54 has the capacitor main body 57 having the rectangular parallelepiped shape. Each of the capacitors 54 is positioned so that the thickness direction of the capacitor main body 57 intersects with the axial direction of the motor housing 24.

According to the above configuration, as compared with a case where each of the capacitors 54 is positioned so that the thickness direction of the capacitor main body 57 coincides with the axial direction of the motor housing 24, the area of the capacitor 54 when viewed from the axial direction of the motor housing 24 becomes smaller. Thus, the portion that defines the second accommodating space S22 in the housing 11 may be decreased in size in the direction perpendicular to the axial direction of the motor housing 24. As a result, it is further suppressed that the portion that defines the second accommodating space S22 in the housing 11 vibrates.

In addition, according to the above configuration, as compared with the case where each of the capacitors 54 is positioned so that the thickness direction of the capacitor main body 57 coincides with the axial direction of the motor housing 24, a length of each of the capacitors 54 in the axial direction of the motor housing 24 becomes larger. Thus, the portion that defines the outer peripheral accommodating space S22a in the housing 11 increases in size in the axial direction of the motor housing 24. As a result, it is further suppressed that the portion that defines the second accommodating space S22 in the housing 11 vibrates.

(1-4) The inverter 16 has the choke coil 55 and the capacitors 54 as the second heat generation components 16b. The potting material 59 includes the coil-heat transfer portion 59a and the capacitor-heat transfer portions 59b. The coil-heat transfer portion 59a is disposed between the motor housing 24 and the choke coil 55 and in contact with both of the motor housing 24 and the choke coil 55. Each of the capacitor-heat transfer portions 59b is disposed between the motor housing 24 and the corresponding capacitor 54 and in contact with both of the motor housing 24 and the capacitor 54.

According to the above-described configuration, both of the choke coil 55 and the capacitors 54 are efficiently cooled.

In addition, according to the above-described configuration, as compared with a case in which the choke coil 55 and the capacitors 54 are arranged in a radial direction of the motor housing 24, the portion that defines the second accommodating space S22 in the housing 11 may be decreased in size in the radial direction of the motor housing 24. As a result, the vibration of the portion that defines the second accommodating space S22 in the housing 11 is further suppressed.

Furthermore, according to the above configuration, as compared with the case in which the choke coil 55 and the capacitors 54 are arranged in the radial direction of the motor housing 24, the portion that defines the outer peripheral accommodating space S22a in the housing 11 increases in size in a circumferential direction of the motor housing 24. As a result, in the portion serving as the rib that defines the outer peripheral accommodating space S22a in the housing 11, the function of the rib is enhanced, so that it is further suppressed that the portion that defines the second accommodating space S22 in the housing 11 vibrates.

(1-5) The suction port 11a and the separation surface 240 of the motor housing 24 are arranged in the axial direction of the motor housing 24. With this arrangement, as compared with a case where the suction port 11a and the separation surface 240 of the motor housing 24 are not arranged in the axial direction of the motor housing 24, the suction port 11a is positioned near the outer peripheral accommodating space S22a, that is, the second heat generation components 16b. A temperature of the refrigerant in the suction chamber S1 is lowest around the suction port 11a, so that this arrangement enhances a cooling effect of the refrigerant on the second heat generation components 16b.

(1-6) The choke coil 55 is disposed so that the one of the pair of the core end surfaces 60a in the core 60 faces the motor housing 24 with the potting material 59 interposed therebetween. This arrangement makes a cooling area of the choke coil 55 larger, so that the choke coil 55 is further efficiently cooled.

(1-7) Each of the capacitors 54 is disposed so that the one of the pair of the capacitor main surfaces 57a faces the motor housing 24 with the potting material 59 interposed therebetween. This arrangement makes a cooling area of each of the capacitors 54 larger, so that the capacitor 54 is further efficiently cooled.

(1-8) The heat transferring member is the potting material 59. Thus, the heat transferring member not only transfers the heat from the second heat generation components 16b to the motor housing 24, but also may fix the second heat generation components 16b to the motor housing 24.

(1-9) The inverter 16 has the conductive ring 56 as the second heat generation component 16b. Accordingly, the conductive ring 56 is efficiently cooled.

(1-10) The potting material 59 is provided only between the motor housing 24 and each of the second heat generation components 16b. Accordingly, as compared with a case where the potting material 59 is positioned so that the potting material 59 covers almost the entire second heat generation component 16b as in a second embodiment, which will be described later, the amount of the potting material 59 used may be reduced.

### Second Embodiment

The following will describe the second embodiment of an electric compressor with reference to FIG. 6. Note that a detailed description in the same configuration as that of the first embodiment is omitted. The following will describe a case where the second heat generation component 16b is the coil unit 53 as one example. However, the second heat generation component 16b is not limited to the coil unit 53.

As illustrated in FIG. 6, the closing wall 26 has a right-angle wall 30 extending from a surface that defines the inverter accommodating chamber S2 in the closing wall 26. The right-angle wall 30 has a first wall portion 31 and a pair of second wall portions 32. Note that in FIG. 6, only one of the pair of second wall portions 32 is illustrated. The first wall portion 31 is positioned outside the coil unit 53 in the radial direction of the motor housing 24. In other words, the coil unit 53 is located between the motor housing 24 and the first wall portion 31 in the radial direction of the motor housing 24. The pair of second wall portions 32 connects the first wall portion 31 to the motor housing 24 in the radial direction of the motor housing 24. The outer peripheral accommodating space S22a has a filled portion 33 defined by the motor housing 24, the closing wall 26, and the right-angle wall 30. The filled portion 33 is filled with the potting material 59.

The coil unit 53 is accommodated in the filled portion 33. The potting material 59 is provided not only between the motor housing 24 and the coil unit 53, but also between the closing wall 26 and the coil unit 53 and between the right-angle wall 30 and the coil unit 53. That is, almost the entire coil unit 53 is covered with the potting material 59. The potting material 59 is in contact with all of the motor housing 24, the closing wall 26, the right-angle wall 30, and the coil unit 53.

The coil unit 53 is accommodated in the outer peripheral accommodating space S22a as follows. In a state where the housing 11 is positioned in a posture such that the first accommodating space S21 of the inverter accommodating chamber S2 is located vertically above the suction chamber S1, the potting material 59 in liquid form is poured into the filled portion 33. Then, the coil unit 53 is accommodated in the filled portion 33 filled with the potting material 59. After that, the potting material 59 cures.

### Advantageous Effects of the Present Embodiment

The following will describe advantageous effects of the present embodiment. In the present embodiment, the following advantageous effects are provided in addition to the effects (1-1) to (1-9) of the first embodiment.

(2-1) The outer peripheral accommodating space S22a has the filled portion 33 filled with the potting material 59. The second heat generation component 16b is accommodated in the filled portion 33.

According to the above-described configuration, an area of the second heat generation component 16b that is covered with the potting material 59 increases, so that a heat dissipation performance of the second heat generation component 16b is enhanced.

The potting material 59 may be provided between the motor housing 24 and the second heat generation component 16b only by accommodating the second heat generation component 16b in the filled portion 33 filled with the potting material 59. Thus, as compared with the first embodiment in which the potting material 59 is provided only between the motor housing 24 and each of the second heat generation components 16b, the potting material 59 is easily provided between the motor housing 24 and the second heat generation component 16b.

### Third Embodiment

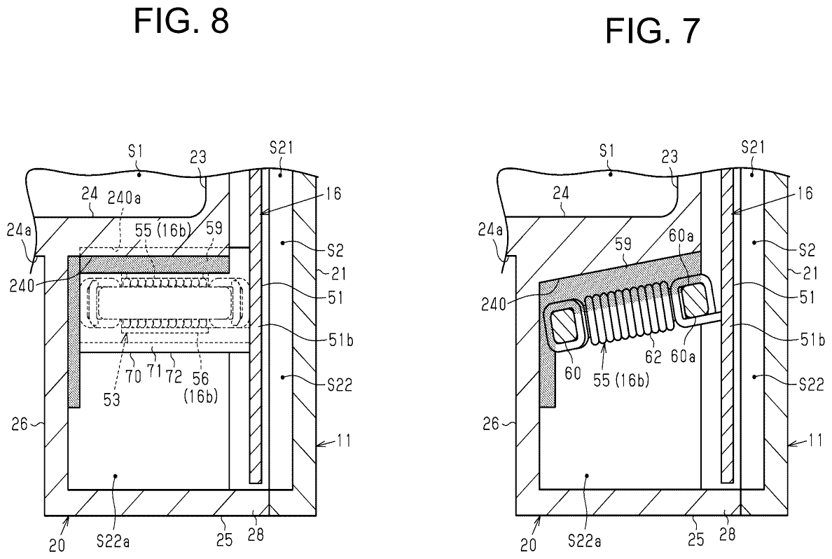

The following will describe a third embodiment of an electric compressor with reference to FIG. 7. Note that a detailed description in the same configuration as that of the first embodiment is omitted. The following describes a case where the second heat generation component 16b is the choke coil 55 as one example. However, the second heat generation component 16b is not limited to the choke coil 55.

As illustrated in FIG. 7, the separation surface 240 of the motor housing 24 is an inclined surface that is inclined away from the suction chamber S1 in the direction perpendicular to the axial direction of the motor housing 24 as the separation surface 240 extends away from the first accommodating space S21 in the axial direction of the motor housing 24. The choke coil 55 is positioned so that the one of the core end surfaces 60a extends along the separation surface 240 being the inclined surface. That is, the pair of the core end surfaces 60a of the core 60 is inclined away from the suction chamber S1 in the direction perpendicular to the axial direction of the motor housing 24 as the core end surfaces 60a extend away from the first accommodating space S21 in the axial direction of the motor housing 24.

In the present embodiment, the potting material 59 is provided not only between the motor housing 24 and the choke coil 55, but also between the closing wall 26 and the choke coil 55. The potting material 59 provided between the closing wall 26 and the choke coil 55 is in contact with both of the closing wall 26 and the choke coil 55.

The choke coil 55 is accommodated in the outer peripheral accommodating space S22a as follows. In the state where the housing 11 is positioned in the posture such that the first accommodating space S21 of the inverter accommodating chamber S2 is positioned vertically above the suction chamber S1, the potting material 59 in liquid form is applied to the separation surface 240 of the motor housing 24. In addition, the potting material 59 in the liquid form is applied to the surface that defines the outer peripheral accommodating space S22a in the closing wall 26. Then, the choke coil 55 is accommodated in the outer peripheral accommodating space S22a along the separation surface 240 so that the choke coil 55 is in contact with the potting material 59 applied to the separation surface 240. When the choke coil 55 is accommodated in the outer peripheral accommodating space S22a, the potting material 59 applied to the surface that defines the outer peripheral accommodating space S22a in the closing wall 26 adheres to the choke coil 55. After that, the potting material 59 cures.

### Advantageous Effects of the Present Embodiment

The following will describe advantageous effects of the present embodiment. In the present embodiment, the following advantageous effects are provided in addition to the effects (1-1) to (1-8) of the first embodiment.

(3-1) For example, in a case where the separation surface 240 of the motor housing 24 is a surface along the axial direction of the motor housing 24, when the choke coil 55 is accommodated in the outer peripheral accommodating space S22a, the applied potting material 59 may be pushed against vertically downward by the choke coil 55 or may drip down because of gravity. In this case, the potting material 59 may not be positioned at a desired position between the motor housing 24 and the choke coil 55.

On the contrary, in the present embodiment, the separation surface 240 of the motor housing 24 is the inclined surface that is inclined away from the suction chamber S1 in the direction perpendicular to the axial direction of the motor housing 24 as the separation surface 240 extends away from the first accommodating space S21 in the axial direction of the motor housing 24. Thus, when the choke coil 55 is accommodated in the outer peripheral accommodating space S22a, the applied potting material 59 is hardly pushed against by the choke coil 55 and hardly drips down. As a result, the potting material 59 is easily provided at the desired position between the motor housing 24 and the choke coil 55.

(3-2) The choke coil 55 is positioned so that the choke coil 55 extends along the separation surface 240 being the inclined surface. With this configuration, the potting material 59 easily adheres to the choke coil 55.

(3-3) The inverter 16 has the choke coil 55 as the second heat generation component 16b. The choke coil 55 has the core 60 formed in the ring shape and the first coil 61 and the second coil 62 wound around the core 60. The choke coil 55 is disposed so that the one of the core end surfaces 60a of the core 60 faces the motor housing 24 with the potting material 59 interposed therebetween. With this configuration, the potting material 59 is easily poured into an inside of the core 60, so that a cooling effect on the choke coil 55 is enhanced.

(3-4) The potting material 59 is provided between the motor housing 24 and the second heat generation component 16b and between the closing wall 26 and the second heat generation component 16b. Thus, as compared with the first embodiment in which the potting material 59 is provided only between the motor housing 24 and the second heat generation component 16b, the heat dissipation performance of the second heat generation component 16b is enhanced. In addition, as compared with the second embodiment in which the potting material 59 is positioned so that the potting material 59 covers almost the entire second heat generation component 16b, the amount of the potting material 59 used may be reduced.

### Fourth Embodiment

The following will describe a fourth embodiment of an electric compressor with reference to FIG. 8 to FIG. 10. Note that a detailed description in the same configuration as that of the first embodiment is omitted. The following will describe a case where the second heat generation component 16b is the coil unit 53 as one example. However, the second heat generation component 16b is not limited to the coil unit 53.

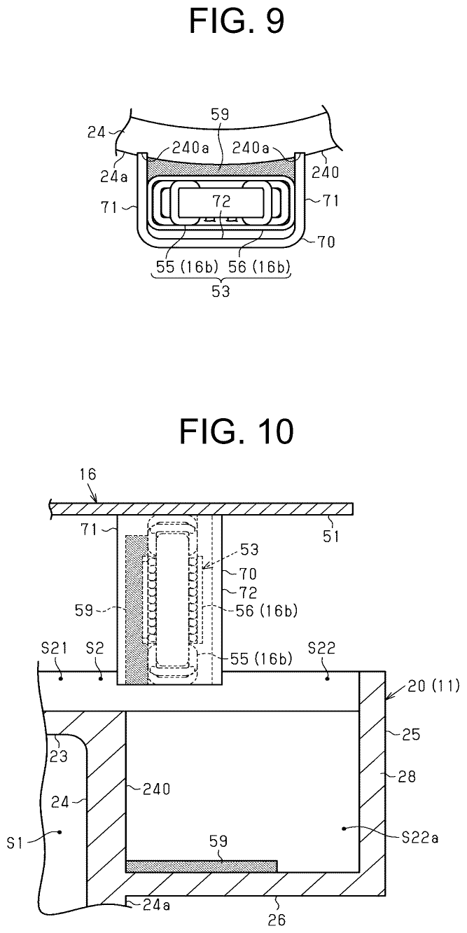

As illustrated in FIG. 8 and FIG. 9, the inverter 16 has a holder 70 that holds the coil unit 53. The holder 70 of the present embodiment is made of resin. The holder 70 of the present embodiment has a pair of restricting portions 71 and a connecting portion 72 that connects the restricting portions 71 to each other. The pair of the restricting portions 71 and the connecting portion 72 are each formed in a flat plate shape. The pair of the restricting portions 71 holds the coil unit 53 therebetween in the circumferential direction of the motor housing 24. The connecting portion 72 is located outside the coil unit 53 in the radial direction of the motor housing 24. In other words, the coil unit 53 is located between the motor housing 24 and the connecting portion 72 in the radial direction of the motor housing 24.

The separation surface 240 of the motor housing 24 has a pair of grooves 240a. The pair of the grooves 240a extends in parallel along the axial direction of the motor housing 24. A distance between the pair of the grooves 240a is substantially the same as a distance between the pair of the restricting portions 71. End portions of the pair of restricting portions 71 are inserted in the pair of grooves 240a.

The potting material 59 provided between the motor housing 24 and the choke coil 55 is located between the pair of the restricting portions 71. The potting material 59 is also provided between the closing wall 26 and the choke coil 55. The potting material 59 provided between the closing wall 26 and the choke coil 55 is in contact with both of the closing wall 26 and the choke coil 55.

The coil unit 53 is accommodated in the outer peripheral accommodating space S22a as follows.

As illustrated in FIG. 10, the housing 11 is positioned in the posture such that the first accommodating space S21 of the inverter accommodating chamber S2 is located vertically above the suction chamber S1. The coil unit 53 is disposed between the pair of the restricting portions 71 of the holder 70 in advance. The potting material 59 in liquid form is applied to the pair of the restricting portions 71 and the coil unit 53 between the pair of the restricting portions 71. In addition, the potting material 59 in the liquid form is applied to the surface that defines the outer peripheral accommodating space S22a in the closing wall 26. Then, the coil unit 53 is accommodated in the outer peripheral accommodating space S22a together with the holder 70. At this time, the end portions of the pair of the restricting portions 71 of the holder 70 are inserted into the pair of the grooves 240a. The potting material 59 provided between the pair of restricting portions 71 adheres to the separation surface 240 of the motor housing 24. In addition, when the coil unit 53 and the holder 70 are accommodated in the outer peripheral accommodating space S22a, the potting material 59 applied to the surface that defines the outer peripheral accommodating space S22a in the closing wall 26 adheres to the coil unit 53. After that, the potting material 59 cures.

### Advantageous Effects of the Present Embodiment

The following will describe advantageous effects of the present embodiment. In the present embodiment, the following advantageous effects are provided in addition to the effects (1-1) to (1-9) of the first embodiment and the effect (3-4) of the third embodiment.

(4-1) The inverter 16 has the holder 70 that holds the coil unit 53. The holder 70 has the pair of the restricting portions 71 that holds the coil unit 53 therebetween in the circumferential direction of the motor housing 24. The potting material 59 is located between the pair of the restricting portions 71. With this configuration, the pair of the restricting portions 71 makes it difficult that the potting material 59 provided between the motor housing 24 and the coil unit 53 flows out toward opposite sides in the circumferential direction thereof.

(4-2) The separation surface 240 of the motor housing 24 has the pair of grooves 240a into which the pair of restricting portions 71 are inserted. With this configuration, the pair of the restricting portions 71 is inserted into the pair of the grooves 240a, which makes it difficult that the potting material 59 flows out from a gap between each of the restricting portions 71 and the motor housing 24.

In addition, this configuration makes the positioning of the holder 70 and the coil unit 53 with respect to the motor housing 24 easier.

### Modification

The above-described embodiments may be modified as follows. The above-described embodiments and the following modification may be combined with each other as long as they do not technically contradict each other.

The configuration of the housing 11 may be changed as appropriate.

For example, in the above-described embodiment, the separation wall 23, the motor housing 24, the inverter housing 25, and the closing wall 26 are formed integrally with each other as the housing main body 20; however, they need not be formed integrally.

The heat transferring member is not limited to the potting material 59. The heat transferring member may be other material, such as a heat dissipation sheet.

In the above-described embodiments, the second heat generation components 16b are the coil unit 53 and the capacitors 54; however, the second heat generation components 16b may be any one of the coil unit 53 and the capacitors 54.

The second heat generation components 16b may be components other than the choke coil 55, the conductive ring 56, and the capacitors 54.

In the first embodiment, the second embodiment, and the fourth embodiment, the inverter 16 need not have the conductive ring 56.

In the third embodiment, the inverter 16 may have the conductive ring 56.

In the first embodiment, the potting material 59 may be provided at a position other than between the motor housing 24 and each of the second heat generation components 16b. For example, the potting material 59 may be also provided between the closing wall 26 and each of the second heat generation components 16b.

In the second embodiment, the entire outer peripheral accommodating space S22a may be the filled portion 33. Here, the right-angle wall 30 is unnecessary.

In the second embodiment, the coil unit 53 and the capacitors 54 may be accommodated together in the filled portion 33.

In the third embodiment and the fourth embodiment, as long as the potting material 59 is provided between the motor housing 24 and the coil unit 53, the potting material 59 need not be provided between the closing wall 26 and the coil unit 53.

In the third embodiment, the second heat generation component 16b need not be positioned so that the second heat generation component 16b extends along the inclined separation surface 240. The choke coil 55 as the second heat generation component 16b may be positioned so that the pair of the core end surfaces 60a of the core 60 extends along the axial direction of the motor housing 24, for example.

In the fourth embodiment, the material of the holder 70 is not limited to resin. The material of the holder 70 may be changed as appropriate.

In the fourth embodiment, as long as the holder 70 has the pair of the restricting portions 71, a shape of the holder 70 may be changed as appropriate. The connecting portion 72 may be located between the coil unit 53 and the closing wall 26, for example.

In the fourth embodiment, the pair of the grooves 240a need not be formed on the separation surface 240 of the motor housing 24. Also in this case, the effect of (4-1) of the above-described fourth embodiment is provided.

In the first embodiment, the second embodiment, and the fourth embodiment, the choke coil 55 is positioned so that the axial direction of the core 60 is perpendicular to the axial direction of the motor housing 24; however, the present disclosure is not limited thereto.

As one example, the choke coil 55 may be positioned so that the axial direction of the core 60 intersects with the axial direction of the motor housing 24 as in the third embodiment. Also in this case, the same effect as the effect (1-2) of the first embodiment is provided.

As another example, the choke coil 55 may be positioned so that the axial direction of the core 60 coincides with the axial direction of the motor housing 24.

The choke coil 55 may be positioned so that the axial direction of the core 60 intersects with the axial direction of the motor housing 24 and a part of the outer peripheral surface of the core 60 faces the motor housing 24 with the potting material 59 interposed therebetween. Also in this case, the same effect as the effect (1-2) of the first embodiment is provided.

In the first embodiment, each of the capacitors 54 is positioned so that the thickness direction of the capacitor main body 57 is perpendicular to the axial direction of the motor housing 24; however, the present disclosure is not limited thereto.

As one example, each of the capacitors 54 may be positioned so that the thickness direction of the capacitor main body 57 intersects with the axial direction of the motor housing 24. Also in this case, the same effect as the effect (1-3) of the first embodiment is provided.

As another example, each of the capacitors 54 may be positioned so that the thickness direction of the capacitor main body 57 coincides with the axial direction of the motor housing 24.

Each of the capacitors 54 may be positioned so that the thickness direction of the capacitor main body 57 intersects with the axial direction of the motor housing 24 and a surface of the capacitor 54 that connects the pair of the capacitor main surfaces 57a to each other faces the motor housing 24 with the potting material 59 interposed therebetween. Also in this case, the same effect as the effect (1-3) of the first embodiment is provided.

The choke coil 55 and the capacitor 54 may be arranged in the radial direction of the motor housing 24. In this case, the potting material 59 may be provided between the motor housing 24 and the component that is located at the innermost in the radial direction of the motor housing 24, among the choke coil 55 and the capacitor 54.

Specifically, when the choke coil 55 is positioned inside the capacitor 54 in the radial direction of the motor housing 24, the potting material 59 has the coil-heat transfer portion 59a provided between the choke coil 55 and the motor housing 24. When the capacitor 54 is positioned inside the choke coil 55 in the radial direction of the motor housing 24, the potting material 59 has the capacitor-heat transfer portion 59b provided between the capacitor 54 and the motor housing 24.

The compression part 14 is not limited to a scroll type compression part.

The compression part 14 may be a piston type compression part 14 and a vane type compression part 14, for example.

The electric compressor 10 may be used in devices other than the air conditioner for vehicles. For example, the electric compressor 10 may be mounted on a fuel cell vehicle. The electric compressor 10 is used to compress air as a fluid that is supplied to fuel cells by the compression part 14.

### Supplementary Notes The following will describe technical ideas that can be obtained from the above-described embodiments and modifications.

### Supplementary Note 1

An electric compressor that includes: a compression part configured to compress a fluid; an electric motor configured to drive the compression part;
an inverter configured to drive the electric motor; and a housing made of metal, the housing having: a motor housing formed in a cylindrical shape, the motor housing accommodating the electric motor and defining a suction chamber into which the fluid is sucked; an inverter housing defining an inverter accommodating chamber accommodating the inverter; and a separation wall separating the suction chamber from the inverter accommodating chamber in an axial direction of the motor housing, the inverter accommodating chamber having: a first accommodating space that is disposed next to the suction chamber in the axial direction of the motor housing with the separation wall interposed between the first accommodating space and the suction chamber; and a second accommodating space that is located outside an outer peripheral surface of the motor housing when viewed in the axial direction of the motor housing, and the inverter having a heat generation component that is accommodated in the second accommodating space, characterized in that the second accommodating space has an outer peripheral accommodating space that is disposed next to the suction chamber in a direction perpendicular to the axial direction of the motor housing with the motor housing interposed between the second accommodating space and the suction chamber, the heat generation component is accommodated in the outer peripheral accommodating space, a heat transferring member is provided between the motor housing and the heat generation component, and the heat transferring member is in contact with both of the motor housing and the heat generation component.

### Supplementary Note 2

The electric compressor according to supplementary note 1, characterized in that the heat transferring member is made of a potting material, the outer peripheral accommodating space has a filled portion filled with the potting material, and the heat generation component is accommodated in the filled portion.

### Supplementary Note 3

The electric compressor according to supplementary note 1, characterized in that the heat transferring member is made of a potting material, and a separation surface that defines the outer peripheral accommodating space in the motor housing is an inclined surface that is inclined away from the suction chamber in the direction perpendicular to the axial direction of the motor housing as the separation surface extends away from the first accommodating space in the axial direction of the motor housing.

### Supplementary Note 4

The electric compressor according to supplementary note 3, characterized in that the heat generation component is positioned so that the heat generation component extends along the inclined surface.

### Supplementary Note 5

The electric compressor according to supplementary note 4, characterized in that the heat generation component includes a choke coil having a core that is formed in a ring shape and a first coil and a second coil wound around the core, and the choke coil is disposed so that an end surface of the core in an axial direction of the core faces the motor housing with the potting material interposed between the end surface and the motor housing.

### Supplementary Note 6

The electric compressor according to supplementary note 1, characterized in that the heat transferring member is made of a potting material, the inverter has a holder that holds the heat generation component, the holder has a pair of restricting portions that hold the heat generation component between the restricting portions in a circumferential direction of the motor housing, and the potting material is located between the pair of the restricting portions.

### Supplementary Note 7

The electric compressor according to supplementary note 6, characterized in that a pair of grooves into which the pair of the restricting portions is inserted is formed on the separation surface of the motor housing that defines the outer peripheral accommodating space.

### Supplementary Note 8

The electric compressor according to any one of supplementary notes 1 to 7, characterized in that the inverter includes a choke coil as the heat generation component having a core that is formed in a ring shape and a first coil and a second coil wound around the core, and the choke coil is positioned so that an axial direction of the core intersects with the axial direction of the motor housing.

### Supplementary Note 9

The electric compressor according to any one of supplementary notes 1 to 8, characterized in that the inverter includes a capacitor as the heat generation component having a capacitor main body that is formed in a rectangular parallelepiped shape, a direction in which a pair of capacitor main surfaces that are outer surfaces with a largest area among the outer surfaces of the capacitor main body is arranged is defined as a thickness direction of the capacitor main body, and the capacitor is positioned so that the thickness direction of the capacitor main body intersects with the axial direction of the motor housing.

### Supplementary Note 10

The electric compressor according to any one of supplementary notes 1 to 9, characterized in that the inverter has a choke coil and a capacitor as the heat generation component, and the heat transferring member includes: a coil-heat transfer portion that is provided between the motor housing and the choke coil and in contact with both of the motor housing and the choke coil; and a capacitor-heat transfer portion that is provided between the motor housing and the capacitor and in contact with both of the motor housing and the capacitor.

What is claimed is:

1. An electric compressor comprising:
a compression part configured to compress a fluid;
an electric motor configured to drive the compression part;
an inverter configured to drive the electric motor; and
a housing made of metal, the housing having:
a motor housing formed in a cylindrical shape, the motor housing accommodating the electric motor and defining a suction chamber into which the fluid is sucked;
an inverter housing defining an inverter accommodating chamber accommodating the inverter; and
a separation wall separating the suction chamber from the inverter accommodating chamber in an axial direction of the motor housing, the inverter accommodating chamber having:
a first accommodating space that is disposed next to the suction chamber in the axial direction of the motor housing with the separation wall interposed between the first accommodating space and the suction chamber; and
a second accommodating space that is located outside an outer peripheral surface of the motor housing when viewed in the axial direction of the motor housing, and
the inverter having a heat generation component that is accommodated in the second accommodating space, wherein
the second accommodating space has an outer peripheral accommodating space that is disposed next to the suction chamber in a direction perpendicular to the axial direction of the motor housing with the motor housing interposed between the second accommodating space and the suction chamber,
the heat generation component is accommodated in the outer peripheral accommodating space,
a heat transferring member is provided between the motor housing and the heat generation component, and
the heat transferring member is in contact with both of the motor housing and the heat generation component.

2. The electric compressor according to claim 1, wherein
the heat transferring member is made of a potting material,
the outer peripheral accommodating space has a filled portion filled with the potting material, and
the heat generation component is accommodated in the filled portion.

3. The electric compressor according to claim 1, wherein
the heat transferring member is made of a potting material, and
a separation surface that defines the outer peripheral accommodating space in the motor housing is an inclined surface that is inclined away from the suction chamber in the direction perpendicular to the axial direction of the motor housing as the separation surface extends away from the first accommodating space in the axial direction of the motor housing.

4. The electric compressor according to claim 3, wherein
the heat generation component is positioned so that the heat generation component extends along the inclined surface.

5. The electric compressor according to claim 4, wherein
the heat generation component includes a choke coil having a core that is formed in a ring shape and a first coil and a second coil wound around the core, and
the choke coil is disposed so that an end surface of the core in an axial direction of the core faces the motor housing with the potting material interposed between the end surface and the motor housing.

6. The electric compressor according to claim 1, wherein
the heat transferring member is made of a potting material,
the inverter has a holder that holds the heat generation component,
the holder has a pair of restricting portions that hold the heat generation component between the restricting portions in a circumferential direction of the motor housing, and
the potting material is located between the pair of the restricting portions.

7. The electric compressor according to claim 6, wherein
a pair of grooves into which the pair of the restricting portions is inserted is formed on the separation surface of the motor housing that defines the outer peripheral accommodating space.

8. The electric compressor according to claim 1, wherein
the inverter includes a choke coil as the heat generation component having a core that is formed in a ring shape and a first coil and a second coil wound around the core, and
the choke coil is positioned so that an axial direction of the core intersects with the axial direction of the motor housing.

9. The electric compressor according to claim 1, wherein
the inverter includes a capacitor as the heat generation component having a capacitor main body that is formed in a rectangular parallelepiped shape,
a direction in which a pair of capacitor main surfaces that are outer surfaces with a largest area among the outer surfaces of the capacitor main body is arranged is defined as a thickness direction of the capacitor main body, and
the capacitor is positioned so that the thickness direction of the capacitor main body intersects with the axial direction of the motor housing.

10. The electric compressor according to claim 1, wherein
the inverter has a choke coil and a capacitor as the heat generation component, and
the heat transferring member includes:
a coil-heat transfer portion that is provided between the motor housing and the choke coil and in contact with both of the motor housing and the choke coil; and
a capacitor-heat transfer portion that is provided between the motor housing and the capacitor and in contact with both of the motor housing and the capacitor.
